(19) United States
(12) Patent Application Publication
(10) Pub. No.: US 2008/0010127 A1
(43) Pub. Date: Jan. 10, 2008

(54) Intelligent mail system to coordinate direct mail with other marketing channels using mail prediction and mail control

(75) Inventors: John W. Rojas, Norwalk, CT (US); Kenneth G. Miller, Bethel, CT (US); John H. Winkelman, Southbury, CT (US); Carlos Reyes, East Haven, CT (US); James R. Norris, Danbury, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/450,533

(22) Filed: Jun. 9, 2006

(51) Int. Cl. G06Q 30/00

(52) U.S. Cl. 705/14

(57) ABSTRACT

A coordinated direct marketing contact strategy between the direct mailing and the other marketing channels. The method determines the marketing prospect names that are common between the direct mailing and the other marketing channels being used in the direct marketing campaign. Then, using mail prediction with the common names between marketing channels the method determines the probability of the prospect receiving the mail piece on a certain date or dates. For each common name the method calculates the contact date(s) for the other contact channels based on the marketers contact strategy and the predicted in home dates. The method then aggregates the individual contact strategies into an overall contact strategy which enables other channels to coordinate with the direct mailing. This process is repeated over several campaigns to benchmark campaign performance that can then be used to analyze and refine future campaign execution.

### FIELD OF THE INVENTION

This invention relates to marketing to a prospective population using more than one marketing channel and more specifically coordinating the marketing channels with some contact strategy.

### BACKGROUND OF THE INVENTION

Direct mail marketers have faced increasing challenges in maintaining response rates to their marketing programs. There are certain variables that have been historically controllable such as the creative, offer and incentive for the mail piece itself. The direct mail marketer has not been able to reasonably measure the sensitivity to day of week that the prospect receives the mail piece, nor been able, in any reasonable way to control when the prospect actually receives the mail piece.

Establishing in home date sensitivity provides the direct mail marketer a critical new capability—The ability to understand prospect population behavior around mail open-ability; that is there are certain days of the week when direct mail is simply discarded and other days of the week when the prospect population may open the mail, increasing the propensity of the prospect to act on the offer.

Once in home date sensitivity is established the challenge becomes one of controlling the mail steam in such a way that the maximum amount of mail arrives when the prospect is most likely to open and act on the offer. Getting control of the mail stream requires complex calculation in order to determine the appropriate time to induct the mail at each of the approximately 400 different large processing facilities in the USPS network. Direct mail marketers are further constrained by balancing postage discounts—a non-sorted mail piece costs 27 cents to mail with machinable mail sorted to five-digit zip order and inducted at the destination SCF costing 16.4 cents per piece. For a direct mail marketing campaign consisting of 1 million pieces the difference in postage is $106,000 a significant amount of money in light of the fact that for most direct mail marketers postage is the single largest cost component in the campaign.

A disadvantage of the prior art is that direct mail marketers have a limited ability to determine when prospects receive a mail piece and direct mail marketers are unable to measure the elapsed time between when the prospect receives the mail piece and when the prospect acts on the offer. The time may be anywhere from immediately to sometime later. Thus, the marketers have difficulty staffing call centers and fulfillment operations. Hence, more people may be hired when they are not needed, or there are not enough people to handle all the orders and, consequently, business is lost.

Another disadvantage of the prior art is that when direct mail marketers use mail piece tracking they typically do not have sufficient time to schedule a contact strategy for prospects receiving mail pieces

A further disadvantage of the prior art is that if direct mail marketers used only tracking they would have to track 100% of the mail in order to know when each prospect received the mail piece.

Marketing campaigns today are done using a variety of different channels, such as direct mail, telephone, email, television, and radio. While certain campaigns may focus more on one channel than another, campaigns in general will still use more than one channel in order to maximize campaign results. When using more than one channel, each tends to be viewed as separate from the other, and not in the context of all channels used. Isolating each and not understanding the connections between channels can lead to an overload effect with marketing recipients, where they encounter a campaign in multiple forms all at once, potentially discouraging them from responding to the campaign. Additionally, marketing investment is not well leveraged, since channels do not build on each other. For example, instead of using a direct mailing preceded by a telemarketing call (or the reverse), the customer is hit all at once when only one channel was needed to communicate the message. The process of marketing between channels is viewed as trying to utilize each as much as possible irrespective of timing, and without a clear plan between them. Increased costs result from the inability to coordinate and the resulting waste, and revenues decrease with customers overloaded by the number of ways that a message was delivered concurrently.

### SUMMARY OF THE INVENTION

This invention overcomes the disadvantages of the prior art by creating a coordinated direct marketing contact strategy between the direct mailing and the other marketing channels. The method determines the marketing prospect names that are common between the direct mailing and the other marketing channels being used in the direct marketing campaign. Then, using mail prediction with the common names between marketing channels the method determines the probability of the prospect receiving the mail piece on a certain date or dates. For each common name the method calculates the contact date(s) for the other contact channels based on the marketers contact strategy and the predicted in home dates. The method then aggregates the individual contact strategies into an overall contact strategy which enables other channels to coordinate with the direct mailing. This process is repeated over several campaigns to benchmark campaign performance that can then be used to analyze and refine future campaign execution.

This invention overcomes the disadvantages of the prior art by: determining a coordinated contact strategy, determining the prospect names that are common between direct mail and the other marketing channels; determining the date(s) with probability distribution of in-homing on each date for each common prospect to be marketed to using mail prediction; calculating contact dates for other channels using mail prediction and coordinated contact strategy; contacting using other channel(s) based upon calculated contact dates; optionally removing names that have responded; revising contact strategy based on measures establishing shipment tracking and optimal contact period and channel grouping.

An advantage of invention is that by knowing, for each prospect, the in home date(s) probability distribution for each date the marketer can coordinate the other channel(s) contact strategy to happen before, during and after the mail piece arrives at the prospect. This significantly increases the ways a contact strategy can be created.

A further advantage of invention is that the mail pieces do not have to be individually tracked. The mail pieces may be partially tracked or they may not be tracked at all.

This invention may be used by marketers by sending a mail piece to a potential customer and then since the marketer knows when the mail piece is received by the customer, the marketer may contact the customer by telephone, e-mail, interactive television, television, radio, etc.

In an alternate embodiment of this invention, the invention determines the induction date required for a mail piece to arrive in home on a specific date or window of dates. It can also be used to coordinate direct mail given an existing strategy for other marketing means. The method determines the marketing prospect names that are common between the direct mailing and the other marketing channels being used in the direct marketing campaign. Given the optimal date or window of dates for mail to arrive in home the method uses mail control to control the in home dates accordingly. Then using mail prediction with the common names between marketing channels the method determines the probability of the prospect receiving the mail piece on a certain date or dates. Thereafter the process continues as described above.

### BRIEF DESCRIPTION OF THE DRAWINGS

FIG. 1 is a flow chart of the direct marketing channel coordination process using mail prediction;

FIG. 2 is a flow chart of the direct marketing channel coordination process using mail control; and

FIGS. 3A and 3B is a flow chart of a direct marketing channel coordination process for contacting prospects using multiple channels.

### DETAILED DESCRIPTION OF THE DRAWINGS

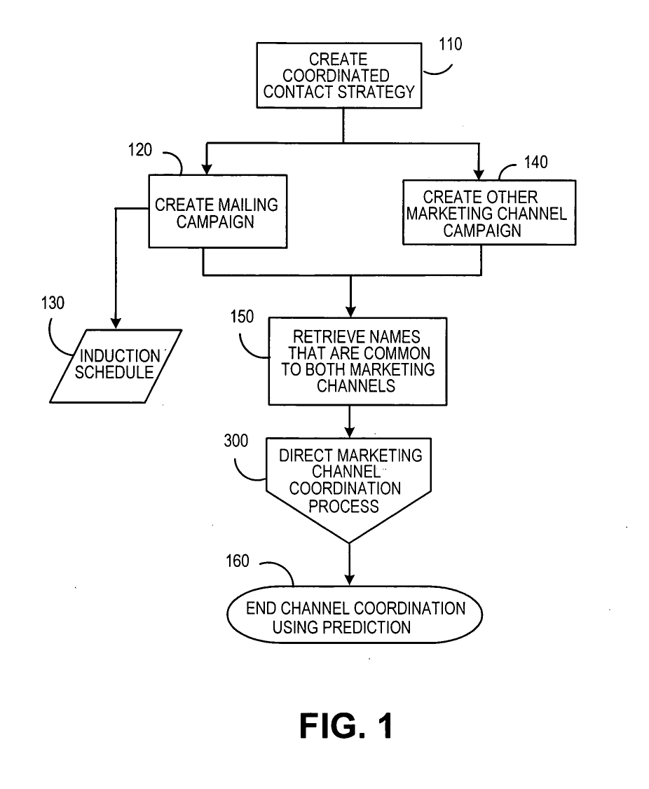

Referring now to the drawings in detail and more particularly to FIG. 1, the process starts in Step 110, Create Coordinated Contact Strategy, where the prospects to contact are selected and the strategy for contacting them is determined based on demographics, historical results, creative, offer, contact lists, etc. The process continues in step 120, Create Mailing Campaign, where the mail for the mailing campaign is produced, and prepared to be delivered to the Carrier by the Shipper. Once the Shipper has processed the mailing campaign, the Induction Schedule, as indicated in Step 130, is produced by the shipper that indicates when individual shipments within the Mailing Campaign will be inducted by the Carrier. At the same time, the other marketing channel campaign being coordinated is created and prepared for execution, as indicated in Step 140.

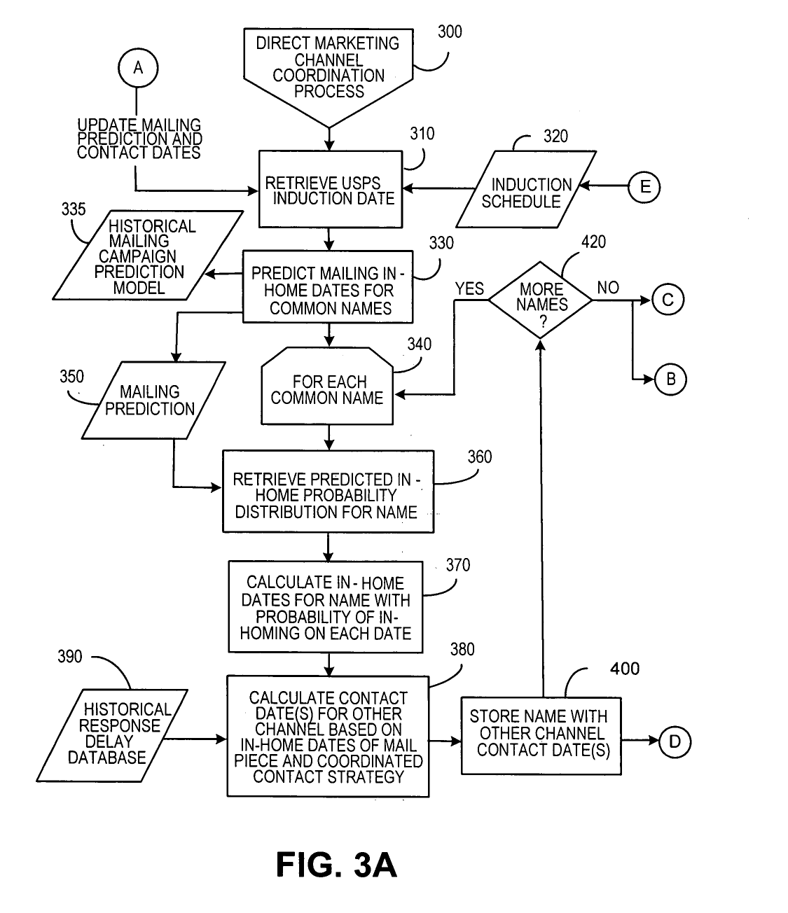

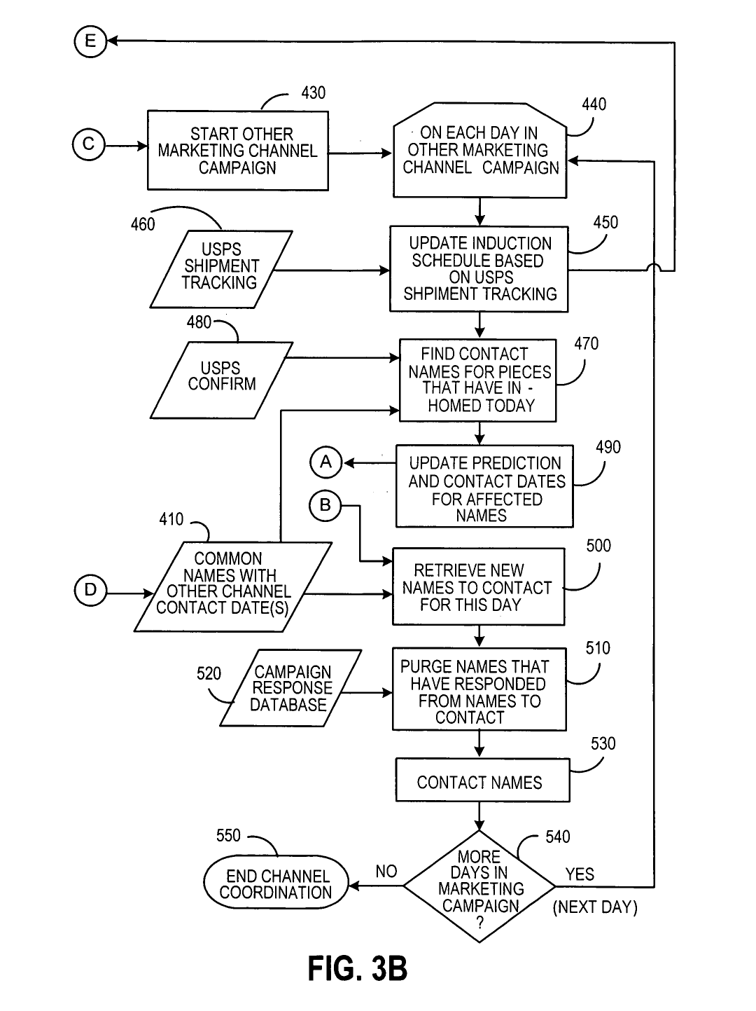

The process continues with Step 150, Retrieve Names that are Common to both Marketing Channels, where a list is prepared of the recipient names that are common between the Mailing Campaign and the Other Marketing Channel Campaign. Once the list is prepared, the process continues in Step 300, Direct Marketing Channel Coordination Process (FIG. 3). Once the Direct Marketing Channel Coordination Process completes, the process finishes in Step 160, End Channel Coordination using Mail Prediction.

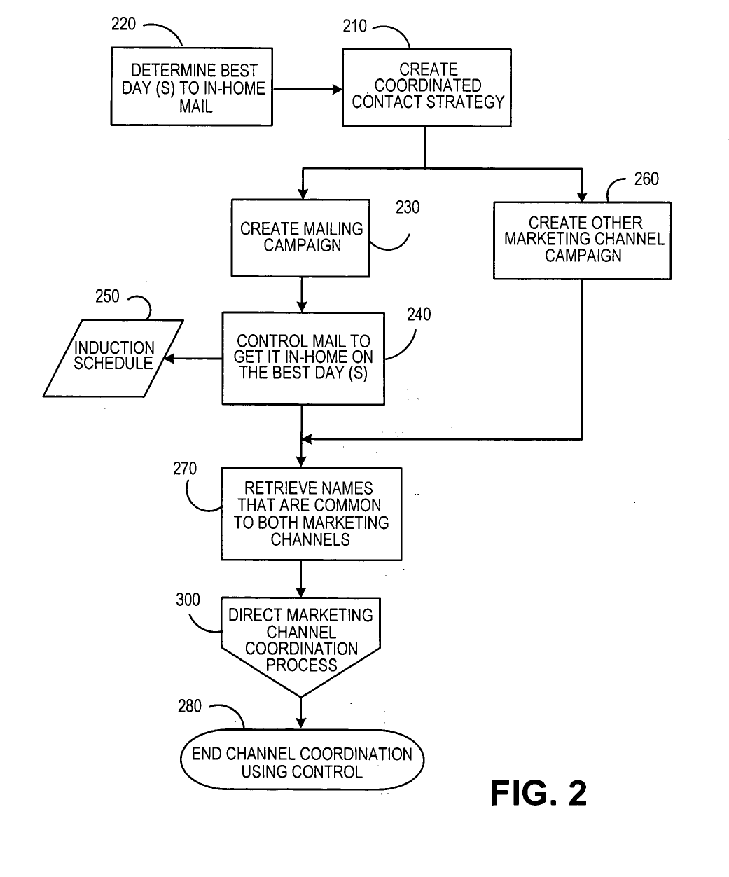

FIG. 2 is a flow chart of the direct marketing channel coordination process using mail control. The process starts in Step 210, Create Coordinated Contact Strategy, where the prospects to contact are selected and the strategy for contacting them is determined based on demographics, historical results, creative, offer, contact lists, etc. In addition, Step 220 provides information for the best days to have the mail delivered to the recipient (at their home or office), based on historical campaign performance results, demographics, and campaign requirements. The process continues in step 230, Create Mailing Campaign, where the mail for the mailing campaign is produced, and prepared to be delivered to the Carrier by the Shipper. Then, in Step 240, the Mailing Campaign is controlled to have the mail delivered to recipients in the best days, as specified earlier. Step 240 is more fully described in the assignee Pitney Bowes Inc. of this patent application co-pending U.S. patent application Ser. No. 11/372,890, filed, Mar. 10, 2006, entitled “Method For Controlling When Mail Is Received By A Recipient”, herein incorporated by reference. Then an Induction Schedule is produced, as indicated in Step 250 that indicates when individual shipments within the Mailing Campaign will be inducted by the Carrier. With the Induction Schedule, the Shipper will proceed to deliver the mail to the Carrier facilities on the scheduled dates.

At the same time, the other marketing channel campaign being coordinated is created and prepared for execution, as indicated in Step 260.

The process continues with Step 270, Retrieve Names that are Common to both Marketing Channels, where a list is prepared of the recipient names that are common between the Mailing Campaign and the Other Marketing Channel Campaign. Once the list is prepared, the process continues in Step 300, Direct Marketing Channel Coordination Process (FIG. 3). Once the Direct Marketing Channel Coordination Process completes, the process finishes in Step 280, End Channel Coordination using Mail Control.

FIGS. 3A and 3B is a flow chart of a direct marketing channel coordination process for contacting prospects using multiple channels. The process starts in Step 300, (FIG. 3A) Direct Marketing Channel Coordination Process and is followed by Step 310, Retrieve USPS Induction Date, where the induction dates are retrieved for each shipment from the Induction Schedule in Step 320. If the Induction Schedule has been updated, then an updated induction date is retrieved.

Then in Step 330, Predict Mailing In-Home Dates for Common Names, where prediction curves are generated for the mailing campaign, for each shipment in the mailing campaign, and each container in each shipment, with the probability of how much mail will be delivered to the recipients on each day in the campaign. Steps 330, 335 and 350 are more fully described in the assignee Pitney Bowes Inc. of this patent application co-pending U.S. patent application Ser. No. 11/373,557, filed, Mar. 10, 2006, entitled “Method For Predicting When Mail Is Received By A Recipient”, herein incorporated by reference. A Historical Mailing Campaign Prediction Model, as indicated in Step 335, is used to create the prediction curves. The prediction curves are stored in the Mailing Prediction in Step 350, and then in Step 340, each one of the Common Names is retrieved in order to calculate the best Contact Date for that name. Then in Step 360, the In-Home probability prediction curve is retrieved for the container associated with the Contact Name from the Mailing Prediction in Step 350. The process proceeds to Step 370, where the container (or Common Name) prediction curve is translated into a list of in-home dates, each with the associated probability of in homing on that date. Then, in Step 380, the Contact Date for the Common Name is calculated based on the in-home date probabilities, Historical Response Delays shown in Step 390, and the Contact Strategy that was created earlier in the process. Then in Step 400, the Common Name and associated Contact Date(s) are stored in the Common Names and other channel Contact Dates Database as shown in Step 410. The process continues in Step 420 where it is determined if more Common Names need to be processed. If more Common Names need to be processed, the process continues with Step 340, otherwise, the process continues with Step 430.

Step 430 (FIG. 3B), Start Other Marketing Channel Campaign, initiates the other marketing channel campaign by allocating, preparing and scheduling the necessary resources for the campaign. The process continues in Step 440, which is performed at the start of each day of the Other Marketing Channel Campaign. Then, in Step 450, the induction schedule for the Mailing Campaign is updated according to USPS Shipment Tracking, as indicated in Step 460. If a shipment's induction date was changed from the original induction schedule, then the induction schedule shown in Step 320 is updated. Then if mailpiece tracking is enabled, the process continues with Step 470, where the contact names are retrieved for mailpieces that have been delivered to recipients. Then in Step 490, the Mailing Prediction and Contact Dates for Contact Names that were affected by changes to the induction schedule and/or in-home/office date for mailpieces are updated. The process continues with label A, and proceeds with Steps 310 through 420, as hereinbefore described, for the Contact Names affected by the updated induction schedule or mailpiece in-home/office dates. When all corresponding Contact Dates have been updated, the process returns through label B to Step 500, where the Names to contact for the current day in the Other Marketing Channel Campaign are retrieved from the Common Names with Other Channel Contact Dates database, as shown in Step 410.

Once a list of Names to Contact is created for the current day, the process continues with Step 510, where the recipients who have responded to the offer or service are retrieved from the Campaign Response Database as shown in Step 520, and are removed from the list of Names to Contact, if possible. Then in Step 530, the recipients to contact are contacted via the appropriate means, as specified by the Marketing Channel for the Other Marketing Channel Campaign. Then in step 540, if more days are still left in the Other Marketing Channel Campaign, then the process continues with Step 440. If there are no more days left in the Other Marketing Channel Campaign, the process ends in Step 550, End Channel Coordination.

It should be understood that although the present invention was described with respect to mail processing by the USPS, the present invention is not so limited and can be utilized in any application in which mail is processed by any carrier. The present invention may also be utilized for mail other than direct marketing mail, for instance, transactional mail, i.e., bills, charitable solicitations, political solicitations, catalogues etc. Also the expression “in-home” refers to the recipient's residence or place of business.

The above specification describes a new and improved method for coordinating the date a recipient receives a mail piece containing a offer for a product or service with other marketing channels offering the product or the service. It is realized that the above description may indicate to those skilled in the art additional ways in which the principles of this invention may be used without departing from the spirit. Therefore, it is intended that this invention be limited only by the scope of the appended claims.

What is claimed is:

1. A method utilizing a computer for coordinating the date a recipient receives a mail piece containing a offer for a product or service with other marketing channels offering the product or the service said method comprises the steps of:
A. utilizing the composition of a mailing campaign that contains a plurality of mailing shipments that contain a plurality of containers containing a plurality of the mail pieces;
B. determining a optimal contact date for contacting the recipient based on a probability that the recipient will receive the mail piece on a given date; and
C. contacting the recipient using one or more of the other marketing channels on the optimal contact date so that that the recipient is most likely to accept the offer for the product or the service.

2. The method claimed in claim 1, further including the step of:
updating the contact dates for the other marketing channels in the case where the recipient does not receive the mail piece on the most probable date.

3. The method claimed in claim 2, wherein the contact dates are updated based on mail piece tracking information.

4. The method claimed in claim 3, further including the step of:
scanning the mail piece to determine when the recipient receives the mail piece.

5. The method claimed in claim 2, wherein the contact dates are updated based on shipment tracking information.

6. The method claimed in claim 5, further including the step of:
tracking the mail piece shipment to determine when the carrier inducts the shipment containing the mail piece.

7. The method claimed in claim 2, further including the step of:
updating contact dates for the other marketing channels based on mail piece tracking information and the probability that the recipient will receive the mail piece on a given date.

8. The method claimed in claim 2, further including the step of:
updating contact dates for the other marketing channels based on mail piece tracking information or the probability that the recipient will receive the mail piece on a given date.

9. The method claimed in claim 1, wherein the contact dates are determined by using a historical mailing campaign prediction model.

10. The method claimed in claim 1, further including the step of:
using a mailing campaign historical response delay data base to calculate the recipient contact date.

11. The method claimed in claim 1, wherein step b, further includes the steps of:
finding the container that has the recipient mail piece; and
using the container in-home probability distribution to determine the probability that the recipient will receive the mail piece on a given date.

12. The method claimed in claim 1, further including the step of:
aggregating contact strategies for different marketing channels into an overall coordinated contact strategy for a marketing campaign.

13. The method claimed in claim 1, further including the step of:
refining previous campaign contact strategy by benchmarking previous campaigns and comparing the previous marketing campaign to the marketing campaign.

14. The method claimed in claim 1, wherein other marketing channels are selected from the group comprising: telemarketing, e-mail, television, interactive television, billboards, interactive billboards and radio.

15. The method claimed in claim 1, further including the step of:
using statistical analysis to determine the optimal contact strategy.

16. The method claimed in claim 15, further including the step of:
using historical marketing campaign results to refine the marketing campaign contact strategy.
